(19) United States
(12) Patent Application Publication
(10) Pub. No.: US 2003/0010630 A1
(43) Pub. Date: Jan. 16, 2003

(54) Method for manufacturing an electrode and an electrode

(76) Inventors: Veikko Polvi, Pori (FI); Pekka Taskinen, Pori (FI); Tuija Suortti, Pori (FI)

Correspondence Address: Morgan & Finnegan, 345 Park Avenue, New York, NY, 10154, US

(21) Appl. No.: 10/203,845

(22) PCT Filed: Feb. 21, 2001
(86) PCT No.: PCT/FI01/00167

(30) Foreign Application Priority Data
Feb. 23, 2000 (FI) 20000411

(51) Int. Cl. C25B 11/00; C25C 7/02; C25D 17/10; C25D 1/00; B23H 3/04

(52) U.S. Cl. 204/280; 204/281; 204/286.1

(57) ABSTRACT

A method for manufacturing an electrode used in the electrolysis of metals, in which method and electrode plate element (2) is attached to a suspension bar (1), which also serves as a power conductor. The plate element (2) is attached to the suspension bar (1) by means of a diffusion joint. The invention also relates to an electrode.

The present invention relates to a method according to the preamble of claim 1 for manufacturing an electrode. The invention also relates to an electrode according to claim 10.

In the electrolysis of metals, it has for a long time been known to apply a method that uses seed plates which are first separately grown on top of mother plates. The use of such seed plates as electrodes, particularly as cathodes, consisting of the same metal as the metal to be precipitated in the electrolysis, for instance copper, is being gradually put aside, particularly as regards new investments. Many new electrolytic plants have adopted the use of permanent cathodes with plate-like elements that are generally made either of acid-proof steel or titanium.

Permanent cathodes are manufactured according to many different methods, where the main differences have been the structure of the cathode suspension bar and the fastening of the plate element to the suspension bar. Because the suspension bars also serve as power conductors, they should be manufactured so that the power losses are minimal.

In the prior art there are known several different ways for realizing the joining of copper and another metal in the manufacturing of cathode suspension bars. The problematic issue in the suspension bar structure and in joining the plate element to the bar is the fact that in order to conduct a high electric power to the plate element, the suspension bar must include a sufficient amount of a highly electroconductive material, such as copper, because acid-proof steel which is typically used in the plate element is poorly electroconductive, and hence it is out of the question as the sole material of the suspension bar. From commercial markets there is known a structure with an all-copper suspension bar, to which there is welded a plate element made of acid-proof steel by using a wire electrode with a special alloy. One of the drawbacks of this arrangement is that the required special steel welding is not equally corrosion-resistant as the other parts of the cathode. Another drawback is the copper bar's susceptibility to deformation owing to the softness of said suspension bar, particularly when using larger cathode weights. Yet another drawback of the prior art is the difficulty to attach the separate suspension lugs—which the current advanced material processing requires of a permanent cathode—sufficiently securely above the suspension bar.

The object of the present invention is to realize a method for manufacturing an electrode, particularly a cathode, whereby the drawbacks of the known arrangements can be avoided. An object of the invention is to realize a method for joining a copper bar serving as a conductor rail and a cathode plate element made of refined steel together, so that there is achieved a good electric contact, which also is sufficiently strong to carry the load caused by the cathode plate and the material to be electrolyzed thereon. The object of the invention is to achieve a joint with good electroconductive capacities that are maintained even in extended, corrosive conditions.

The invention is characterized by what is specified in the appended claims.

The method according to the invention has several remarkable advantages. By means of the method, there is secured an even distribution of electric power from the conductive rail to the cathode plate. Working steps carried out by welding are no longer needed in the manufacturing of the cathode plate. The method of joining is easily automated in comparison with welding methods. By applying a nickel layer on the steel surface, it is possible to prevent the nickel loss taking place from austenitic stainless steel towards copper, which would cause the steel to be embrittled. The creation of the joint is activated by means of applying a layer of soldering agent on the junction surface of the copper surface and the nickel-plated steel plate. By means of an activator, lower joining temperatures can be used, and as a result the thermal stresses created in the junction area are lower. When the employed suspension bar is a profile bar according to a preferred embodiment of the invention, there is achieved an economical and resistant construction with a sufficient rigidity.

In this application, the term copper refers to, apart from objects made of copper, also to alloy materials with a copper content that essentially includes at least 50% copper. The term stainless steel in this application refers mainly to austenitic alloy steels, such as stainless and acid-proof steels.

The invention is explained in more detail with reference to the appended drawings, where

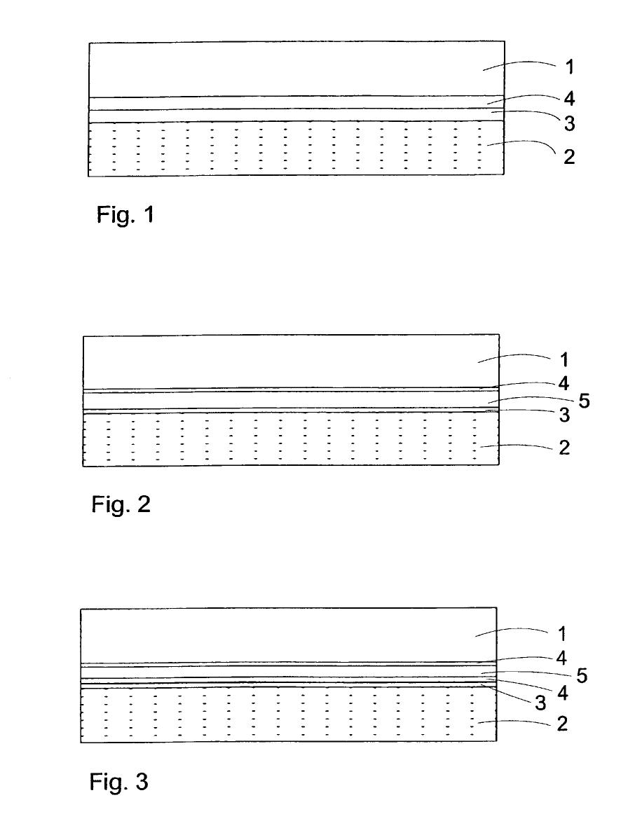

FIG. 1 illustrates the structure of a junction according to the invention prior to the heating step,

FIG. 2 illustrates the structure of another junction according to the invention prior to the heating step, and

FIG. 3 illustrates the structure of a third junction according to the invention prior to the heating step,

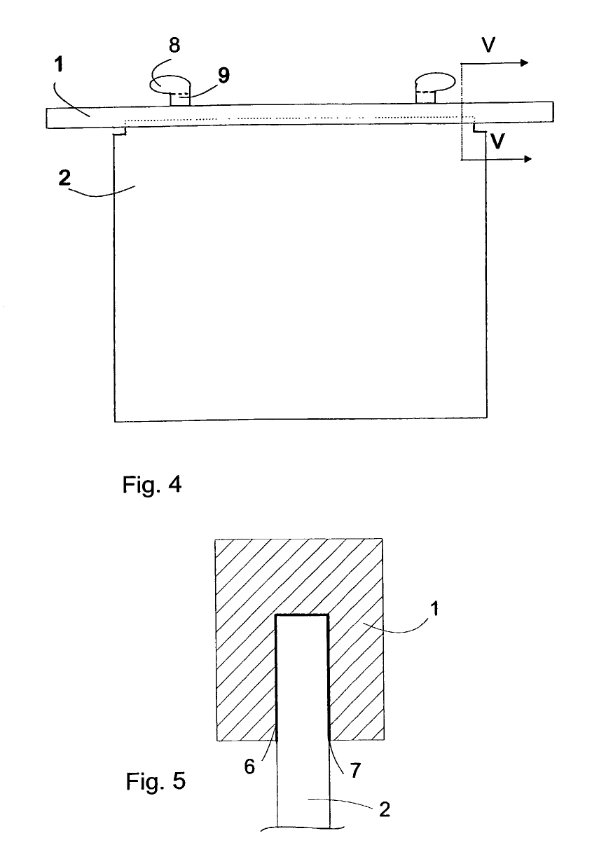

FIG. 4 illustrates an electrode according to the invention, and

FIG. 5 illustrates a detail of the electrode according to the invention, shown in cross-section along the line V-V of FIG. 1.

The invention relates to a method for manufacturing an electrode to be used in the electrolysis of metals, in which method the electrode plate element 2 is attached to the suspension bar 1, which also serves as the power conductor. According to the invention, the plate element 2 is attached, by means of a diffusion joint, to the suspension bar 1. Typically the plate element 2 is attached to the suspension bar at its top part, at least along its essential length. FIGS. 1, 2 and 3 are simplified illustrations of different embodiments of the method of creating the joint prior to the heating step. Prior to forming the joint, in between the junction surfaces of the plate element 2 and the suspension bar 1, there is provided at least one intermediate layer 3, 4, 5. In between the junction surfaces of the plate element 2 and the suspension bar 1, to be joined together, there is provided a first intermediate layer 3 on the junction surface of the plate element 2 or against said surface, and at least a second intermediate layer 4 on the junction surface of the suspension bar 1 or against said surface, so that the junction surfaces including their intermediate layers are pressed together, and in said method, at least the junction area is heated. The employed suspension bar 1 is typically a copper bar or a copper alloy bar that essentially consists of mainly copper. The employed electrode plate element 2 is made of refined steel, preferably austenitic Cr/Ni steel. The first intermediate layer 3 includes mainly nickel (Ni) or chromium (Cr), or an alloy or mixture thereof. The second intermediate layer 4 consists of an activator with a melting temperature that is lower than that of the objects that should be joined together. The second intermediate layer 4 includes mainly silver (Ag) and/or tin (Sn), or, as an alloy or mixture, silver and copper (Ag+Cu), aluminum and copper (Al+Cu) or tin and copper (Sn+Cu).

FIG. 1 illustrates an embodiment of the joining method according to the invention in cross-section prior to the thermal treatment. A suspension bar 1 essentially consisting of copper, and a plate element 2 consisting of stainless steel are thereby joined together. In the junction between the two objects, there are arranged intermediate layers. The intermediate layer 3 placed against the steel includes mainly nickel (Ni). In addition, when creating the joint, there is advantageously used a so-called activator agent 4, which in the case of the example is tin (Sn). Tin functions as the activator and results in a lowering of the temperature, which is required in the creation of the joint.

The intermediate layer 3 can be formed on the surface of the plate element 2 by means of a separate treatment. When nickel is used as the intermediate layer 3, said layer can be created for example by means of electrolysis. Nickel-plating is typically carried out so that the passivation layer provided on the stainless steel surface does not present an obstacle to the material transfer on the junction surface between stainless steel and nickel. The intermediate layer 3 can also be applied in the form of foil.

On the junction surfaces of the objects 1, 2 to be joined together, there is created a diffusion joint 6 (FIG. 5), as a result of the nickel diffusion on one hand, and as a result of the diffusion of the copper and steel components on the other. The formation of the diffusion joint, and the structures created therein, are activated by means of an extremely thin soldering agent layer required by the applied manufacturing conditions and the desired joint, or by means of a combination of several soldering agent layers placed on the junction surface between the nickel-plated steel plate and copper.

The employed soldering agents and diffusion activators are silver-copper alloys and tin in pure form or in specific sandwich structures. Mechanically strong joints are obtained within the temperature range of 700-850° C. The selection of thermal treatment periods can be carried out so that the creation of brittle intermetallic phases in the final joint are avoided. The soldering agent thicknesses, as well as the thermal treatment temperature and duration are chosen so that the nickel loss from steel is prevented as a result of the alloy with a high nickel content provided on the surface thereof. An advantage of a low joining temperature is that the thermal stresses created in the junction area are minimal.

FIG. 2 illustrates another embodiment of the joining method according to the invention prior to the thermal treatment. A suspension bar 1 essentially consisting of copper, and a plate element 2 consisting of stainless steel are thereby joined together. In the junction between the two objects, there are arranged intermediate layers 3, 4, 5. The intermediate layer 3 placed against the steel includes mainly nickel (Ni). In addition, when creating the joint, there is advantageously used a so-called activator agent, which in the case of the example is tin (Sn). Tin functions as the activator and results in a lowering of the temperature, which is required in the creation of the joint. In addition to the tin layer, the joint includes a third intermediate layer 5 made of another soldering agent provided in between the tin layer 4 and the nickel layer 3. In a preferred embodiment, said layer consists of an Ag+Cu soldering agent, advantageously in the form of foil. According to a preferred embodiment, the second soldering agent layer includes Ag 71% and Cu 29%, preferably in a eutectic composition. Advantageously the soldering agent has, with a given alloy composition, a eutectic composition with copper. The junction area is heated in one step. According to a preferred embodiment of the method according to the invention, the second intermediate layer 4 is brought onto the surface of the third intermediate layer 5. Typically, but not necessarily, at least one of the intermediate layers 3, 4, 5 is brought to the junction area in the form of foil. The employed soldering agents and diffusion activators of the intermediate layers 4, 5 can be silver-copper alloys and tin, either in pure form or as specific sandwich structures. Mechanically strong joints are obtained within the temperature range of 600-850° C. The selection of thermal treatment periods can be carried out so that the creation of brittle intermetallic phases in the final joint are avoided. The soldering agent thicknesses, as well as the thermal treatment temperature and duration are chosen so that the nickel loss from steel is prevented as a result of the alloy with a high nickel content provided on the surface thereof. An advantage of a low joining temperature is that the thermal stresses created in the junction area are minimal.

FIG. 3 illustrates yet another embodiment of the method according to the invention prior to heating the suspension bar and the plate element. There a second intermediate layer 4 is provided on both surfaces of the third intermediate layer 5, or against said surfaces. In this embodiment, there can typically be used a sandwich foil, where one or both surfaces of the foil are treated for instance with tin.

The thicknesses of the intermediate layers used in the method vary. The thickness of the Ni layer employed as the first intermediate layer 3 is typically 2-50 μm. After electrolysis, it is typically 2-10 μm, as a foil of the order 20-50 μm. The thickness of the Ag or Ag+Cu foil employed as the third intermediate layer 5 is typically 10-500 μm, preferably 20-100 μm. The thickness of the second intermediate layer 4 is typically dependent on the thickness of the third intermediate layer 5, and it is for instance 10-50% of the thickness of the third intermediate layer. Extremely high-quality joints have been achieved by applying for instance a 5-10 μm tin layer on the surfaces of a 50 μm thick Ag+Cu soldering agent foil. The tin layers can be formed for example by immersing the soldering agent in the form of foil in molten tin, and when necessary, by thereafter rolling the foil to be smooth.

### EXAMPLE I

Acid-proof steel (AISI 316) and copper (Cu) were joined together. On the steel junction surface, there was provided, as a first intermediate layer, a nickel (Ni) layer with the thickness of 7 μm. As a diffusion activator and soldering agent, there was used an Ag+Cu soldering agent having a eutectic composition, including in percentages by weight 71% Ag and 29% Cu. The soldering agent was in the form of foil with the thickness of 50 μm, and on the foil surface there was also formed a tin (Sn) layer with a thickness of the order 5-10 μm. The objects to be joined together were placed against each other, so that the foil was left in between the junction surfaces. The objects were pressed together, and the junction area was heated above the melting temperature of the soldering agent, up to a temperature of about 800° C. The holding time was about 10 minutes. The junction according to the example succeeded extremely well. The obtained result was a metallurgically compact joint, with excellent electroconductive capacities.

Thus the invention also relates to an electrode to be used particularly in the electrolytic plants of metals, said electrode comprising a suspension bar 2 and a plate element 1 attached to said suspension bar. The electrode according to the invention is characterized in that the plate element 1 is attached to the suspension bar 2 by means of a diffusion joint 6 (FIG. 5). Advantageously the plate element 1 is attached essentially along the whole length thereof to the suspension bar 2.

The surface of the suspension bar 1 that falls against the plate element 2 is at least mainly made of copper or copper alloy. Typically the plate element 2 is made of refined steel, particularly acid-proof steel. According to a preferred embodiment of the electrode of the invention, the suspension bar 1 comprises a groove or the like, whereto the counterpart of the plate element 2 is arranged to be fitted in.

According to a preferred embodiment, the electrode according to the invention is a permanent cathode. These are typically used for instance in the electrolysis of copper.

In an electrode according to the invention, there are easily provided suspension elements 8 to be used during transportation. Said suspension elements 8 can be attached for example by fastening means, such as screws or rivets, to the elements 9 extending to above the suspension bar level of the plate element. The suspension means can also be formed of the elements 9 extending to is above the suspension bar of the plate element 2.

1. A method for manufacturing an electrode used in the electrolysis of metals, in which method the plate element (2) of an electrode is attached to a suspension bar (1), which also serves as a power conductor, characterized in that said plate element (2), made of refined steel, is attached to the suspension bar (1), made of a copper or a copper alloy that consists mainly of copper, by means of a diffusion joint, and that in between the junction surfaces of the plate element (2) and the suspension bar (1), there is arranged at least one intermediate layer (3) prior to creating the joint which consists mainly of nickel (Ni) or chromium (Cr) or of an alloy or mixture thereof.

2. A method according to claim 1, characterized in that the plate element (2) is attached to the suspension bar (1) at its top part, at least along its essential length.

3. A method according to claims 1 or 2, characterized in that in between the junction surfaces of the plate element and the suspension bar to be joined together, there is arranged a first intermediate layer (3) on the junction surface of the plate element (2) or against said surface, and a second intermediate layer (4) on the junction surface of the suspension bar (1) or against said surface, whereafter the junction surfaces including their intermediate layers are pressed together, and in which method at least the junction area is heated.

4. A method according to any of the claims 1-3, characterized in that the second intermediate layer (4) consists of an activator with a melting temperature that is lower than the melting temperature of the objects to be joined together.

5. A method according to any of the claims 1-4, characterized in that the second intermediate layer (4) consists mainly of silver (Ag) and/or tin (Sn), or as an alloy or in a mixture, silver and copper (Ag+Cu), aluminum and copper (Al+Cu) or tin and copper (Sn+Cu).

6. An electrode to be used in the electrolytic plants of metals, said electrode comprising a suspension bar (1) and a plate element (2) attached to said suspension bar, characterized in that said plate element (2) is attached to said suspension bar (1) by means of a diffusion joint wherein the surface falling against the plate element (2) of the suspension bar (1) is at least mainly made of copper or copper alloy and the plate element (2) is made of refined steel, particularly acid-proof steel.

7. And electrode according to claim 6, characterized in that the plate element (2) is attached to the suspension bar (1) essentially along the whole length of said plate element (2).

8. And electrode according to claims 6 or 7, characterized in that the suspension bar (1) is provided with a groove (6) or the like, in which the counterpart of the plate element is arranged to be fitted in.

9. And electrode according to any of the claims 6-8, characterized in that the suspension bar (1) is attached on both sides of the plate element (2).

10. And electrode according to any of the claims 6-9, characterized in that said electrode is a permanent cathode.
